(19) United States
(12) Patent Application Publication
(10) Pub. No.: US 2020/0386342 A1
(43) Pub. Date: Dec. 10, 2020

(54) VALVE DEVICE

(71) Applicant: FUJIKIN INCORPORATED, Osaka (JP)

(72) Inventors: Toshihide YOSHIDA, Osaka (JP); Tsutomu SHINOHARA, Osaka (JP); Tomohiro NAKATA, Osaka (JP); Ryutaro TANNO, Osaka (JP); Kouji NISHINO, Osaka (JP); Katsuyuki SUGITA, Osaka (JP); Masahiko TAKIMOTO, Osaka (JP)

(73) Assignee: FUJIKIN INCORPORATED, Osaka (JP)

(21) Appl. No.: 16/971,375

(22) PCT Filed: Mar. 9, 2018
(86) PCT No.: PCT/JP2018/009357

§ 371 Date: Aug. 20, 2020

(51) Int. Cl. F16K 31/00; F16K 1/52

(52) U.S. Cl. CPC F16K 31/007; F16K 1/52

(57) ABSTRACT

A valve device allows simple flow rate control when the bulb is opened. Valve device includes: a valve body having a first flow path and a second flow path formed therein; a valve body for closing an opening of the first flow path to shut off a gateway between the first flow path and the second flow path and for opening the first flow path to communicate the first flow path and the second flow path; an operating member for moving between a closed position for closing the opening in the valve body and an open position for opening the opening; and an adjusting actuator for defining an open position of the operating member and having an electrically driven material made of a compound that deforms in response to a change in an electric field, and for changing the defined open position by deformation of the electrically driven material.

### TECHNICAL FIELD

The present disclosure relates to a valve device, a flow control method, a fluid control device, a semiconductor manufacturing method, and a semiconductor manufacturing apparatus.

### BACKGROUND ART

In semiconductor manufacturing processes, in order to supply an accurately metered process gas to a processing chamber, a fluid control device called an integrated gas system in which various fluid control devices such as open-close valves, regulators or mass flow controllers are integrated is used. The integrated gas system accommodated in the box is called a gas box.

Usually, a process gas outputted from the gas box is directly supplied to a processing chamber, but in a processing process of depositing a film on a substrate by an atomic layer deposition (ALD) method, in order to stably supply the process gas, the process gas supplied from the gas box is temporarily stored in a tank as a buffer, and a valve provided in the immediate vicinity of the processing chamber is frequently opened and closed to supply the process gas from the tank to the processing chamber in a vacuum-atmosphere. As valves provided in the immediate vicinity of the process chamber, see, for example, Patent Literatures 1 and 2.

The ALD method is one of chemical vapor deposition methods, in which two or more types of process gases are alternately flowed on a substrate surface under film forming conditions such as temperature and time to react with atoms on the substrate surface to deposit a film layer by layer, and since every monoatomic layer can be controlled, a uniform film thickness can be formed and a film can be grown very densely as a film quality.

In the semiconductor manufacturing process by the ALD method, it is necessary to precisely adjust the flow rate of the process gas, and along with increase of the diameter of the substrate or the like, it is also necessary to secure a certain amount of flow rate of the process gas.

### PATENT LITERATURE

PLT 1: Japanese Laid-Open Application No. 2007-64333
PLT 2: Japanese Laid-Open Application No. 2016-121776

### SUMMARY OF INVENTION

### Technical Problem

However, in an air-driven valve, it is not easy to precisely adjust the flow rate by pneumatic adjustment or mechanical adjustment. Further, in the semiconductor manufacturing process by the ALD method, since the periphery of the processing chamber becomes high temperature, the valve tends to be influenced by the temperature. Furthermore, since the valve is opened and closed at a high frequency, with the passage of time, aging of the valve is likely to occur, and enormous man-hours of flow rate adjustment work is required to maintain a precise flow rate.

The present invention has been made in view of the above circumstances, it is an object of the present invention to provide a valve device, a flow rate control method and a fluid control apparatus which can more easily adjust the opening amount when opening the valve, and a semiconductor manufacturing method and a semiconductor manufacturing apparatus which can easily adjust the opening amount when opening the valve in a process step by the process gas.

### Solution to Problem

The valve device of the present disclosure is a valve device comprising: a valve body having a first flow path and a second flow path formed therein; a valve element for closing an opening of the first flow path to shut off a gateway between the first flow path and the second flow path, and for opening the opening of the first flow path to make the first flow path and the second flow path communicate with each other; an operating member moving between a closed position for closing the opening of the valve body and an open position for opening the opening; and an adjusting actuator for defining the open position of the operating member and having an electrically driven material made of a compound that deforms in response to a change in an electric field, the adjusting actuator configured to change the defined open position by deformation of the electrically driven material.

Further, in valve device of the present disclosure, the adjusting actuator may have a structure in which a plurality of elements including the electrically driven material is stacked in a moving direction of the operating member.

In the valve device of the present disclosure, the electrically driven material may be a piezoelectric material or an electrically driven polymeric material. In this case, the electrically driven polymeric material may be either an electrical EAP, a nonionic EAP, or an ionic EAP.

Further, the valve device of the present disclosure may further include an elastic member for urging the operating member to the closed position and a main actuator for urging the operating member to the open position against the elastic member.

Further, in the valve device of the present disclosure, the main actuator may move the operating member to the open position by a drive fluid supplied through a flow path a part of which is formed by a side surface of the adjusting actuator.

Further, the valve device of the present disclosure further comprises an annular actuator presser for gripping the adjusting actuator and a wire connected to the adjusting actuator inside the actuator presser, and the actuator presser may have an actuator presser flow passage for making the inside and outside of actuator presser communicate with each other.

Further, the valve device of the present disclosure may further comprise an adjusting body which is attached to the casing of the main actuator and connects the actuator presser, and the adjusting body may have an adjusting body flow passage which opens inside the actuator presser, supplies a drive fluid, and allows a wiring to pass therethrough.

The flow control method of the present disclosure is a flow control method comprising using any one of the above valve devices for regulating a flow rate of a fluid.

The fluid control device of the present disclosure is a fluid control device comprising a plurality of fluid devices, wherein the fluid devices include any of the above valve devices.

The semiconductor manufacturing method of the present disclosure is a semiconductor manufacturing method comprising using any one of the above valve devices to control a flow rate of a process gas in a manufacturing process of a semiconductor device requiring a process step by the process gas in a sealed chamber.

The semiconductor manufacturing apparatus of the present disclosure is a semiconductor manufacturing apparatus comprising any one of the above valve devices to control a flow rate of a process gas in a manufacturing process of a semiconductor device requiring a process step by the process gas in a sealed chamber.

### Advantageous Effects of Invention

According to the valve device, the flow control method and the fluid control device of the present invention, it is possible to more easily adjust the opening amount when opening the valve. Further, according to the semiconductor manufacturing method and the semiconductor manufacturing apparatus of the present invention, it is possible to more easily adjust the opening amount when opening the valve in a process step by a process gas.

### BRIEF DESCRIPTION OF DRAWINGS

FIG. 1 is a longitudinal cross-sectional view of a valve device according to an embodiment of the present invention.

FIG. 2 is an enlarged cross-sectional view in the vicinity of the adjusting actuator of the valve device in FIG. 1 in closed state.

FIG. 3 is an enlarged cross-sectional view in the vicinity of the diaphragm of the valve device in FIG. 1 in closed state.

FIG. 4 is a diagram for explaining the operation of the valve device by supplying a drive fluid.

FIG. 5 is a longitudinal cross-sectional view of the valve device in FIG. 1 in open state.

FIG. 6 is an enlarged cross-sectional view in the vicinity of the adjusting actuator of the valve device in FIG. 5.

FIG. 7 is an enlarged cross-sectional view in the vicinity of the diaphragm of the valve device in FIG. 5.

FIG. 8A is an enlarged cross-sectional view in the vicinity of the actuator for explaining the state of the valve device of FIG. 5 when adjusting the flow rate (when reducing the flow rate is reduced).

FIG. 8B is an enlarged cross-sectional view in the vicinity of the diaphragm for explaining the state of the valve device of FIG. 5 when adjusting the flow rate (when reducing the flow rate).

FIG. 9A is an enlarged cross-sectional view in the vicinity of the actuator for explaining the state of the valve device of FIG. 5 when adjusting the flow rate (when increasing the flow rate).

FIG. 9B is an enlarged cross-sectional view in the vicinity of the diaphragm for explaining the state of the valve device of FIG. 5 when adjusting the flow rate (when increasing the flow rate).

FIG. 10 is a schematic diagram showing an application of the valve device according to the present embodiment to a semiconductor manufacturing process.

FIG. 11 is a perspective view showing an exemplary fluid control device using the valve device of the present embodiment.

### DESCRIPTION OF EMBODIMENTS

Embodiments of the present invention will be described below with reference to the drawings. In the present specification and the drawings, the same reference numerals are used to denote components having substantially the same functions, so that duplicated descriptions are omitted.

First, referring to FIG. 11, an exemplary fluid control device to which the present invention is applied will be described.

The fluid control device shown in FIG. 11 has a metallic base plate BS, on which there provided five rail members 994 each extending in the longitudinal direction G1, G2 and arranged along the width direction W1, W2. Note that W1 represents the front side, W2 represents the back side, G1 represents the upstream side, and G2 represents the downstream side. Various fluid devices 991A to 991E are installed on each of the rail members 994 via a plurality of flow path blocks 992, and a flow path (not shown) through which a fluid flows from the upstream side to the downstream side is formed by the plurality of flow path blocks 992.

Here, a “fluid device” is a device used in a fluid control device for controlling a flow of a fluid, the fluid device comprises a body defining a fluid flow path and having at least two flow path ports opening at the surfaces of the body. Specific examples include, but are not limited to, an open-close valve (two-way valve) 991A, a regulator 991B, a pressure gauge 991C, an open-close valve (three-way valve) 991D, a mass flow controller 991E, and the like. An introduction pipe 993 is connected to an upstream flow path port of a flow path (not shown). In this fluid control device, five flow paths flowing in the G2 direction are formed by fixing a plurality of flow path blocks 992 to five rail members 994, and the length of each flow path in the width direction W1, W2 can be set to 10mm or less, that is, the width (dimension) of each fluid device can be set to 10mm or less for miniaturization and integration.

Although the present invention is applicable to various valve device such as the above-described open-close valves 991A and 991D and the regulator 991B, an exemplifying application of the present invention to an open-close valve (valve device) will be described in the present embodiment.

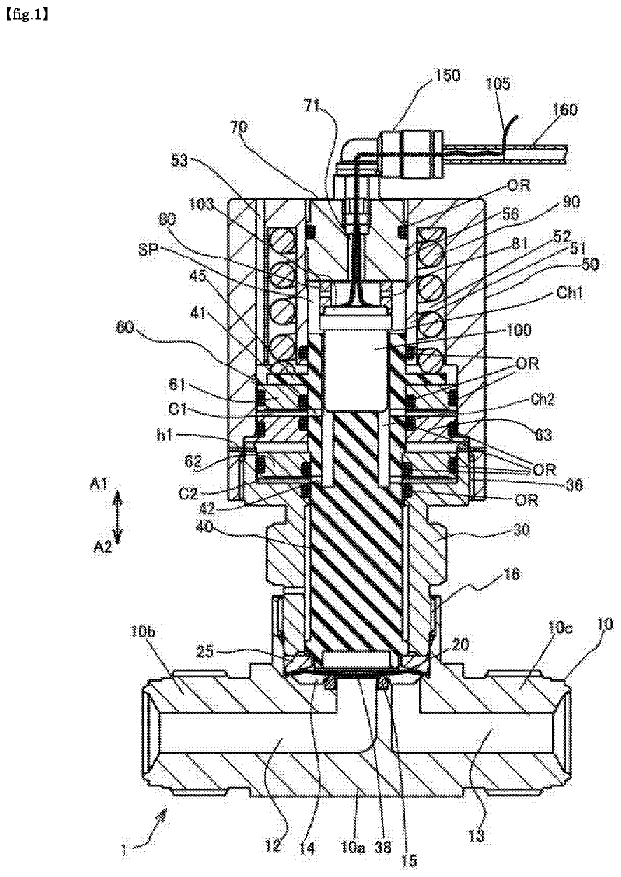

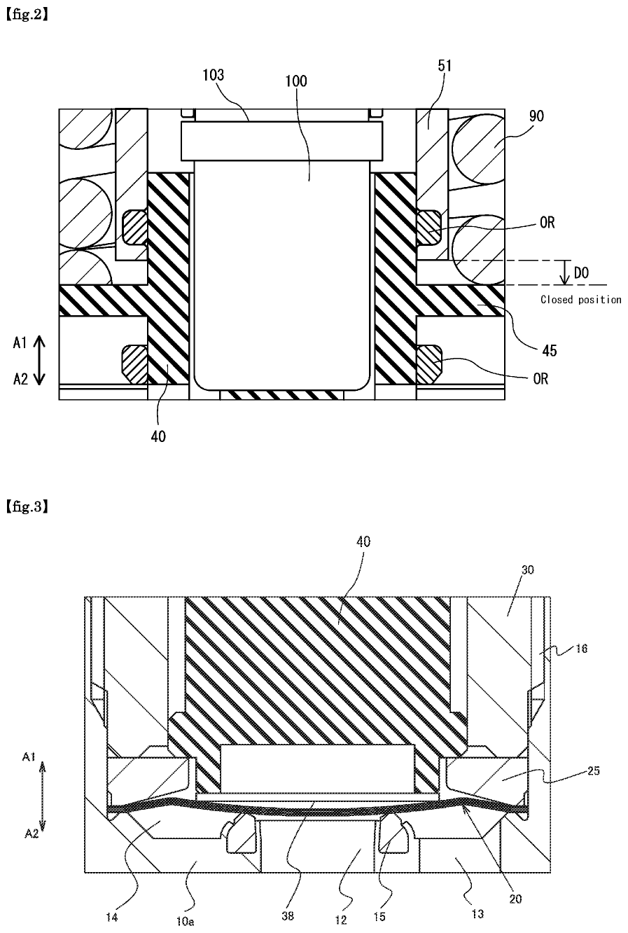

FIG. 1 is a diagram illustrating a configuration of a valve device according to an embodiment of the present invention, in which the valve is in a fully closed state, FIG. 2 is an enlarged cross-sectional view in the vicinity of the adjusting actuator of FIG. 1, and FIG. 3 is an enlarged cross-sectional view in the vicinity of the diaphragm of FIG. 1. In the following description, it is assumed that the upward direction is the opening direction A1 and the downward direction is the closing direction A2.

In FIG. 1, 1 denotes a valve device, 10 denotes a valve body, 20 denotes a diaphragm as a valve element, 38 denotes a diaphragm presser, 30 denotes a bonnet, 40 denotes an operating member, 50 denotes a casing, 60 denotes a main actuator, 70 denotes an adjusting body, 80 denotes an actuator presser, 90 denotes a coil spring, 100 denotes an adjusting actuator, and OR denotes an O-ring as a sealing member.

The valve body 10 is made of stainless steel, has a valve body main portion 10a having a block shape and a connecting portions 10b and 10c protruding from respective sides of valve body main portion 10a, and defines a first flow path 12 and a second flow path 13. The first flow path 12 and the second flow path 13 have one ends opening at end faces of the connecting portions 10b and 10c, respectively, and the other ends are communicating with the concave valve chamber 14 which is open upward. A valve seat 15 made of a synthetic resin (PFA, PA, PI, PCTFE, or the like) is fitted and fixed to a mounting groove provided in a peripheral edge of an opening (hereinafter simply referred to as an “opening”) at the other end of the first flow path 12 on the bottom surface of the valve chamber 14. In the present embodiment, as is clear from FIG. 3, the valve seat 15 is fixed in the mounting groove by crimping, but may be arranged without crimping.

The diaphragm 20 is a valve element that closes the opening of the first flow path 12 of the valve body 10 to shut off the gateway between the first flow path 12 and the second flow path 13, and opens the opening of the first flow path 12 to make the first flow path 12 and the second flow path 13 communicate with each other. The diaphragm 20 is disposed above the valve seat 15, and keeps the valve chamber 14 airtight, and the central portion thereof moves up and down to be seated on and off the valve seat 15, thereby blocking or communicating the first flow path 12 and the second flow path 13. In the present embodiment, the diaphragm 20 is formed by bulging upward the central portion of a metal sheet and a nickel-cobalt alloy sheet such as special stainless steel, to have an upward arcuate convex spherical shell shape in the natural state. In the present embodiment, diaphragm 20 is constituted by three special stainless steel sheets and a nickel-cobalt alloy sheet laminated together.

The peripheral portion of diaphragm 20 is placed on a protruding portion of the inner peripheral surface of the valve chamber 14, and by inserting the lower end portion of the bonnet 30 into the valve chamber 14 and screwing it with a screw portion 16 of the valve body 10, the peripheral portion of diaphragm 20 is pressed against the protruding portion side of the valve body 10 via a presser adapter 25 made of stainless alloy, and thereby sandwiched and fixed in an airtight state. Incidentally, a nickel-cobalt alloy thin film is disposed on a gas-contacting side.

It should be noted that other configurations of the diaphragm can also be used.

Operating member 40 moves between a closed position to make the diaphragm 20, which is a valve element, close the opening of the first flow path 12 and an open position to make the diaphragm 20 open the opening. Operating member 40 is formed in a substantially cylindrical shape, fitted to the inner peripheral surface of a cylindrical portion 51 formed in the casing 50 and the inner peripheral surface of the bonnet 30, and is supported movably in the vertical direction. Incidentally, A1 and A2 shown in FIGS. 1 and 2 are the moving directions of operating member 40, A1 shows the moving direction to the open state of the diaphragm 20, and A2 shows the moving direction to the closed state. In the present embodiment, the upward direction is the opening direction A1 and the downward direction is the closing direction A2 with respect to the valve body 10, but the present invention is not limited thereto.

A diaphragm presser 38 made of a synthetic resin such as polyimide and abutting the upper surface of the central portion of the diaphragm 20 is mounted on the lower end surface of operating member 40.

Between an upper surface of a flange portion 45 formed on the outer peripheral surface of the operating member 40 and a ceiling surface of the casing 50, a coil spring 90 is provided, and the operating member 40 is always biased toward the closing direction A2 by the coil spring 90. Therefore, as shown in FIG. 2, in a state in which the main actuator 60 is not operated, the flange portion 45 is biased by the coil spring 90, and the distance between the flange portion 45 and the cylindrical portion 51 becomes D0. In this state, as shown in FIG. 3, the diaphragm 20 is pressed against the valve seat 15, and the space between the first flow path 12 and the second flow path 13 is closed.

The flange portion 45 may be integral with or separate from operating member 40.

Coil spring 90 is accommodated in a holding portion 52 formed between the inner peripheral surface of the casing 50 and the cylindrical portion 51. Although the coil spring 90 is used in this embodiment, other types of elastic members such as, but not limited to, coned disc springs or leaf springs may be used.

Casing 50 has a lower end portion whose inner periphery is screwed into the screw portion 36 formed on the upper end portion of the outer periphery of the bonnet 30, and thereby the casing 50 is fixed to the bonnet 30. Between the upper end surface of the bonnet 30 and the casing 50, an annular bulkhead 63 is fixed.

Between the outer peripheral surface of operating member 40 and the casing 50 and the bonnet 30, cylinder chambers C1, C2 partitioned into upper and lower sides by the bulkhead 63 are formed.

In the upper cylinder chamber C1, a piston 61 formed in an annular shape is fitted and inserted, and in the lower cylinder chamber C2, a piston 62 formed in an annular shape is fitted and inserted. These cylinder chambers C1 and C2 and the pistons 61 and 62 constitute a main actuator 60 for moving the operating member 40 to an open position against the coil spring 90 which is an elastic member. The main actuator 60 is adapted to use two pistons 61 and 62 to increase the working area of the pressure to thereby increase the force by a drive fluid G.

The space on the upper side of the piston 61 of the cylinder chamber C1 is connected to the atmosphere by the air passage 53. The space on the upper side of the piston 62 of the cylinder chamber C2 is connected to the atmosphere by the air passage h1.

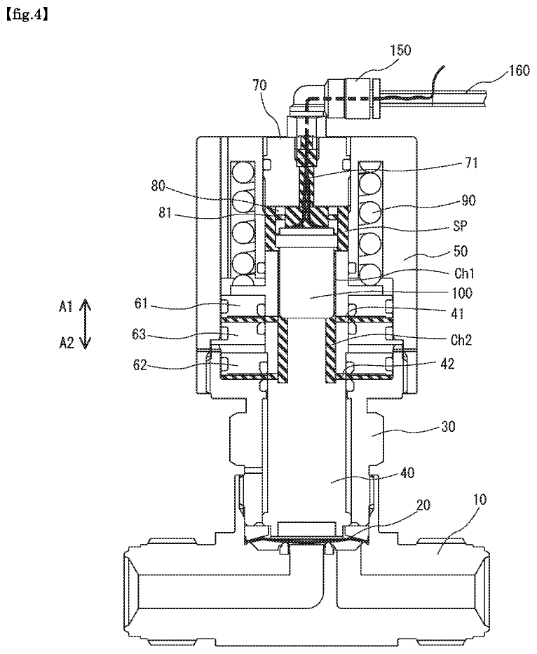

In FIG. 4, the area where the drive fluid G is supplied is shown by hatching. The drive fluid G is, for example, compressed air, but is not limited thereto. In this figure, for clarity of explanation, hatching or the like is omitted in regions other than the region where the drive fluid G is supplied. Since the lower spaces of the pistons 61 and 62 of the cylinder chambers C1 and C2 are supplied with the high-pressure drive fluid G, airtightness is maintained by the O-rings OR. These spaces are in communication with operating member flow passages 41 and 42, respectively, formed in the operating member 40. The operating member flow passages 41 and 42 communicate with the second pneumatic flow passage Ch2 formed inside the operating member 40, and the second pneumatic flow passage Ch2 communicates with the first pneumatic flow passage Ch1 formed between the inner peripheral surface of the operating member 40 and the outer peripheral surface of the adjusting actuator 100, and the first pneumatic flow passage Ch1 communicates with a space SP formed by the upper end surface of the operating member 40 and the cylindrical portion 51 of the casing 50 and the lower end surface of the adjusting body 70. An annular actuator presser 80 which grips the adjusting actuator 100 has an actuator presser flow passage 81 which makes the inside and outside thereof communicate with each other, and the actuator presser flow passage 81 connects the space SP and the adjusting body flow passage 71 which penetrates the center of the adjusting body 70. Adjusting body flow passage 71 communicates with the pipe 160 through the pipe joint 150. As a result, the drive fluid G supplied from the pipe 160 is supplied to the cylinder chambers C1 and C2, and the pistons 61 and 62 are pushed up in the direction A1. Thus, by using the side surface of the adjusting actuator 100 as a part of flow path and supplying the drive fluid G, it is possible to further miniaturize the valve device 1. Here, the lengths of the first pneumatic flow path Ch1 and the second pneumatic flow path Ch2 in the open-close directions A1, A2 can be appropriately determined in accordance with the length of the main actuator 60 in the open-close directions A1, A2, and the length of the adjusting actuator 100 in the open-close directions A1, A2, and in this case, the configuration may be such that without having a second pneumatic flow path Ch2, operating member flow passages 41 and 42 are directly connected to the first pneumatic flow path Ch1.

The adjusting actuator 100 defines the open position of the operating member 40 and has an electrically driven material made of a compound that deforms in response to changes in the electric field. The open position of the operating member 40 may be defined by elastic deformation of the adjusting actuator 100 by the pressure received from the operating member 40. That is, in the adjusting actuator 100, the shape or size of the electrically driven material may vary according to current or voltage to change the open position of operating member 40 as defined. Such an electrically driven material may be a piezoelectric material or an electrically driven material other than the piezoelectric material. When an electrically driven material other than the piezoelectric material is used, an electrically driven type polymeric material can be used.

The electrically driven type polymeric materials, also referred to as electroactive polymer (EAP) materials, include, for example, electric EAP driven by an external electric field or Coulombic force, nonionic EAP in which a solvent that swells the polymer is flown by an electric field to deform the polymer, ionic EAP driven by movement of ions and molecules by an electric field, and the like, and any one or a combination thereof can be used.

As the electric EAP, for example, a piezoelectric polymer such as polyvinylidene fluoride (PVDF) may be used, or a dielectric elastomer such as acrylic rubber or silicon rubber may be used. As the nonionic EAP, for example, a nonionic gel such as a gel in which a polyvinyl alcohol (PVA) gel is swollen with dimethyl sulfoxide (DMSO) as a dielectric solvent can be used.

As the ionic EAP, for example, a nonionic gel such as a PAN-platinum fiber obtained by electroless plating platinum on a polyacrylonitrile (PAN) fiber can be used. Alternatively, an electronically conductive polymer such as polypyrrole or polyaniline may be used, or a bucky gel actuator using a bucky gel obtained by mixing carbon nanotubes and an ionic liquid may be used.

As another ionic EAP, for example, an ionic polymer-metal composite (IPMC) having such a structure in which a thin film electrode made of e.g. gold or platinum is bonded to both surfaces of an electrolyte membrane made of e.g. a fluorine-based ion exchange resin may be used. In particular, as an ionic liquid which swells a IPMC, those obtained by ion-exchange in an aqueous solution of 1-ethyl-3-methylimidazoliumtetrafluoroborate (EMIBF4) (e.g., Nafion®), or those obtained by ion-exchange using 1-ethyl-3-methylimidazoliumtrifluoroacetate (EMITFA) and 1-ethyl-3-methylimidazoliumbis(trifluoromethanesulfonyl)imide (EMITFSI) and sodium hydroxide (NaOH) containing an alkali metal ion (e.g., Nafion® NRE-211), or the like can be used.

The adjusting actuator 100 may be constructed with a plurality of elements, including an electrically driven material, stacked in the direction of travel of the operating member 40. The adjusting actuator 100 may be configured such that the stacked structure is accommodated in a container and deforms together with the container. In this case, each of the plurality of actuator elements is connected to a wiring 105 and its operation is controlled.

As shown in FIG. 1, the power supply to the adjusting actuator 100 is performed by the wiring 105. Wiring 105 is connected to the adjusting actuator 100 inside the actuator presser 80, from which the wiring 105 is guided through the adjusting body flow passage 71 and the pipe joint 150 to the pipe 160, and is drawn from the middle of the pipe 160 to the outside. The externally drawn wiring 105 is connected to a control device (not shown), and the extension of the adjusting actuator 100 is controlled based on the current or voltage from the control device.

The position of the base end portion 103 of the adjusting actuator 100 in the open-close direction is defined by the lower end surface of the adjusting body 70 via the actuator presser 80. Adjusting body 70 has a screw portion provided on the outer peripheral surface, that is screwed into the screw hole 56 formed in the upper portion of the casing 50, and thereby the adjusting body 70 is attached to the casing 50 of the main actuator 60. By adjusting the position of the adjusting body 70 in the open-close direction A1, A2, it is possible to adjust the position of the adjusting actuator 100 in the open-close direction A1, A2. The adjusting body 70 has an adjusting body flow passage 71 which opens inside the actuator presser 80, supplies the drive fluid G, and allows the wiring 105 to pass therethrough.

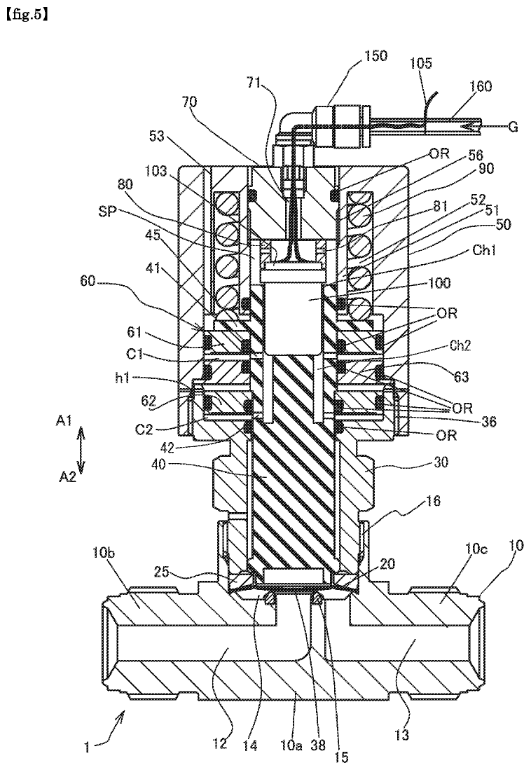

Next, the operation of valve device 1 having the above-described configuration will be described with reference to FIGS. 5 to 9B.

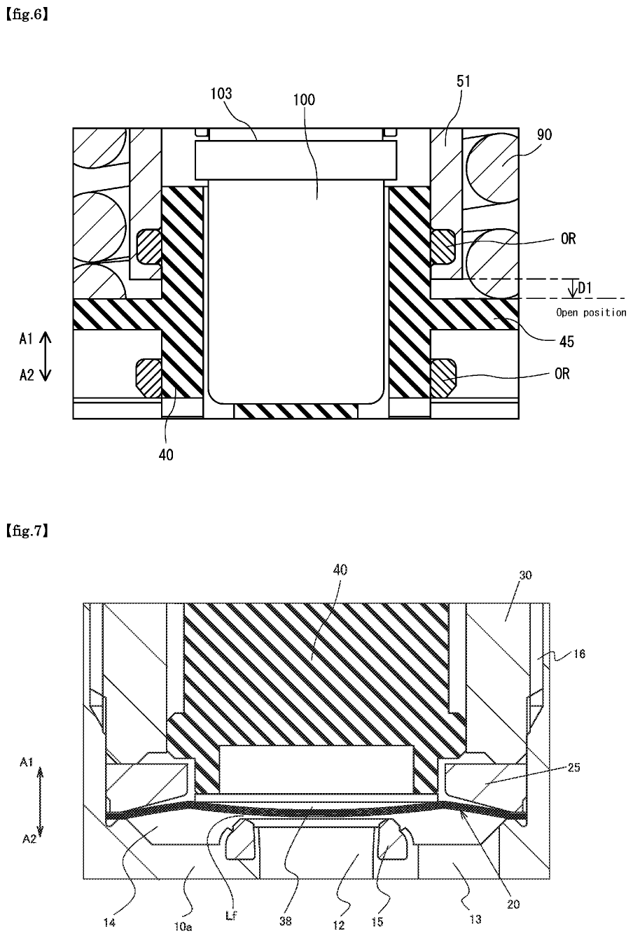

As shown in FIG. 5, when the drive fluid G of a predetermined pressure is supplied into valve device 1 through the pipe 160, a thrust force of the pistons 61 and 62 that pushes up the operating member 40 in the opening direction A1 acts. The pressure of the drive fluid G is set sufficiently to move the operating member 40 in the opening direction A1 against the urging force of the coil spring 90 in the closing direction A2 acting on the operating member 40. The force in the opening direction A1 acting on the operating member 40 is received by the adjusting actuator 100, and the movement of the operating member 40 in the A1 direction is regulated at an open position elastically deformed by the pressure received from operating member 40. In other words, in FIG. 6, the distance between the flange portion 45 and the cylindrical portion 51 becomes a distance D1 smaller than the distance D0 when the operating member is closed position, by the elastic deformation amount of the adjusting actuator 100. In this state, as shown in FIG. 7, the diaphragm 20 is separated from the valve seat 15 by a lift amount Lf in accordance with the amount of elastic deformation. If the amount of elastic deformation of the adjusting actuator 100 is negligible here, for example, it is possible to approximate that the lower surface of the adjusting actuator 100 regulates the open position of the operating member 40.

If it is desired to adjust the flow rate of the fluid output and supplied from the second flow path 13 of valve device 1 in the state shown in FIG. 5, the adjusting actuator 100 is actuated.

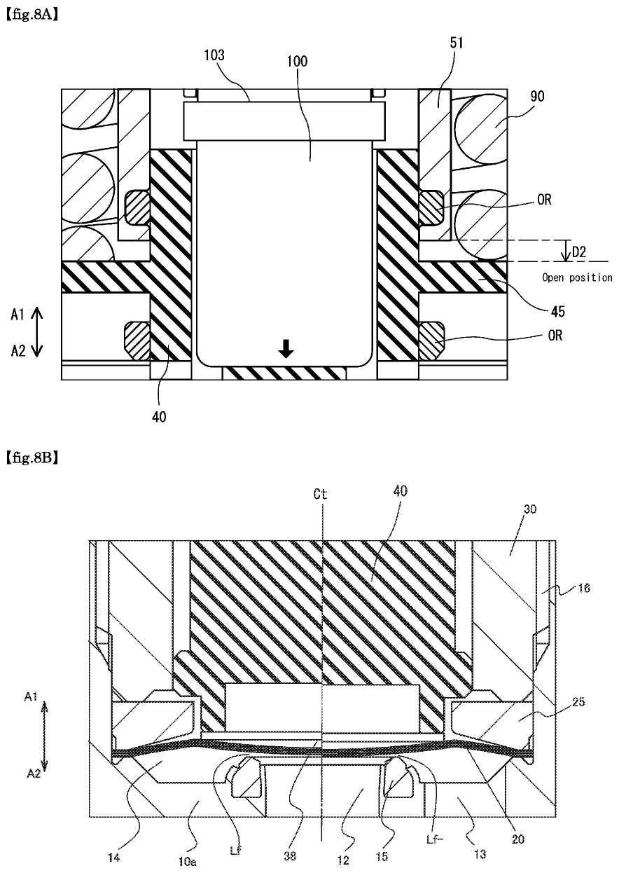

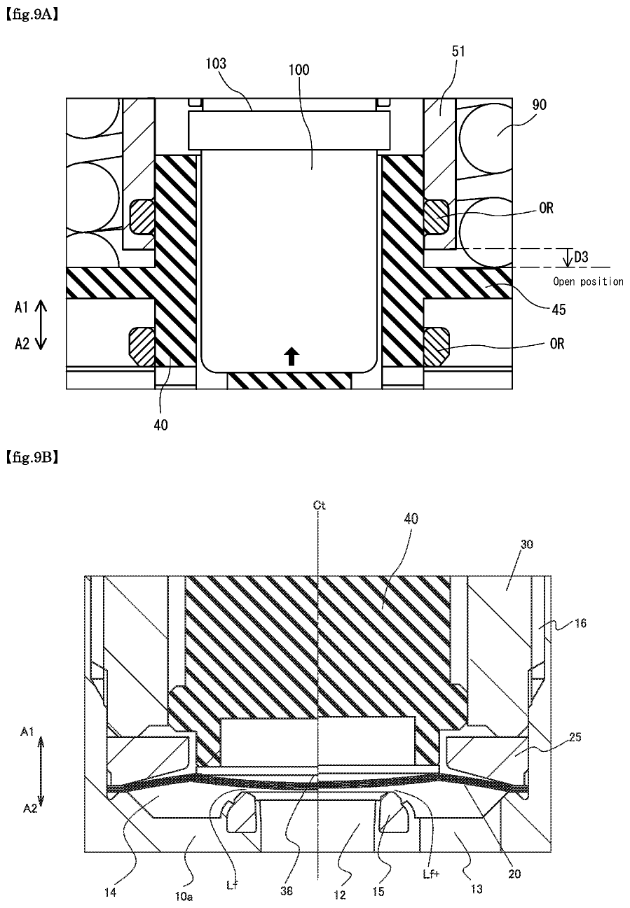

Left side of the center line Ct of the FIGS. 8B and 9B shows the state shown in FIG. 5, the right side of the center line Ct shows the state after adjusting the position of the operating member 40 in open-close direction A1, A2

When adjusting the fluid flow rate in the decreasing direction, as shown in the drawing 8A, the adjusting actuator 100 is extended to move the lower end surface of the adjusting actuator 100 in the closing direction A2 by applying a voltage or the like via the wiring 105, thereby moving the open position of the operating member 40 in the closing direction A2. Thus the amount of movement of the operating member 40 in the open state from the closed position is reduced, and the distance D2 between the flange portion 45 and the cylindrical portion 51 becomes greater than the distance D1 in the normal closed position. Thus, as shown in FIG. 8B, the lift amount Lf− after adjustment, which is the distance between the diaphragm 20 and the valve seat 15, becomes smaller than the lift amount Lf before adjustment.

When adjusting the fluid flow rate in the increasing direction, the operating member 40 is moved in the opening direction A1 by shortening the adjusting actuator 100 and moving the lower end surface of the adjusting actuator 100 in the opening direction A1, as shown in the drawing 9A, by e.g. application of a voltage via the wiring 105. Thus the amount of movement of the operating member 40 in the open state from the closed position is increased, and the distance D3 between the flange portion 45 and the cylindrical portion 51 becomes smaller than the distance D1 in the closed position at the time of normal. Thus, as shown in FIG. 9B, the lift amount Lf+ after adjustment, which is the distance between the diaphragm 20 and the valve seat 15, becomes larger than the lift amount Lf before adjustment.

In the present embodiment, the maximum value of the lift amount of the diaphragm 20 is about 100 to 200 μm, and the adjustment amount by the adjusting actuator 100 is about ±20 μm. However, the adjustment amount is appropriately determined depending on the application of valve device 1 or the material used for the adjusting actuator 100.

That is, although it is not possible to cover the lift amount of the diaphragm 20 by the stroke of the adjusting actuator 100, however, by using the main actuator 60 operated by the drive fluid G and the adjusting actuator 100 in combination, while ensuring the supply flow rate of valve device 1 by the main actuator 60 having a relatively long stroke, it is possible to precisely adjust the flow rate by the adjusting actuator 100 having relatively short stroke, and thus, the flow rate adjusting man-hours are greatly reduced as compared with the case of manually adjusting the flow rate by the adjusting body 70 or the like.

According to the present embodiment, since it is possible to precisely adjust the flow rate only by changing the voltage applied to the adjusting actuator 100, it is possible to execute flow rate adjustment immediately, and it is also possible to perform the flow rate control in real time.

According to the present embodiment, by appropriately selecting the main actuator and the adjusting actuator, it is possible to obtain a required valve opening and to perform precise flow control.

According to the present embodiment, it is possible to more easily adjust the opening amount when opening the valve.

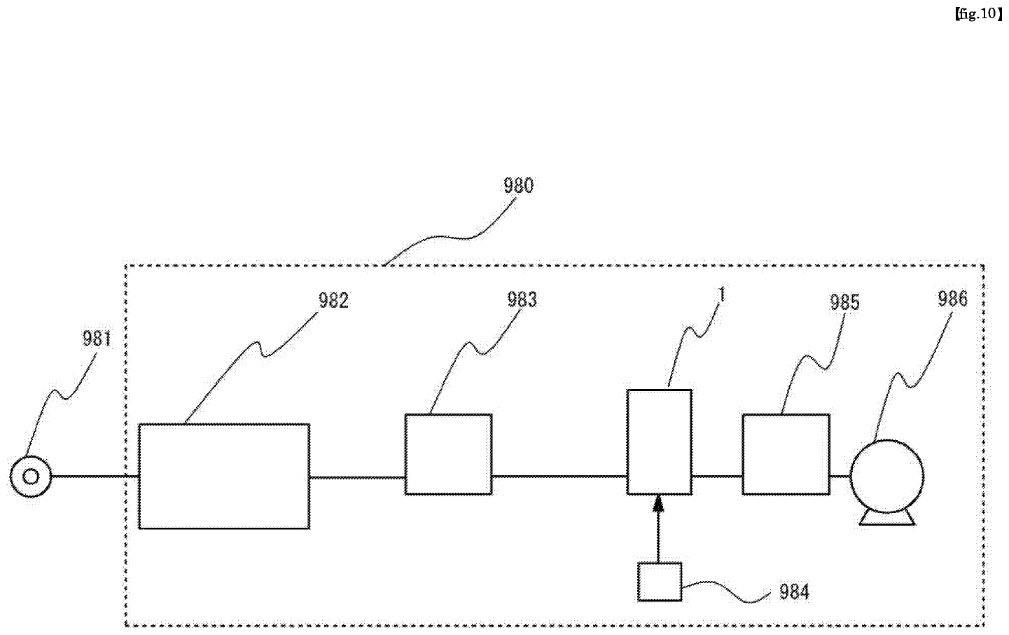

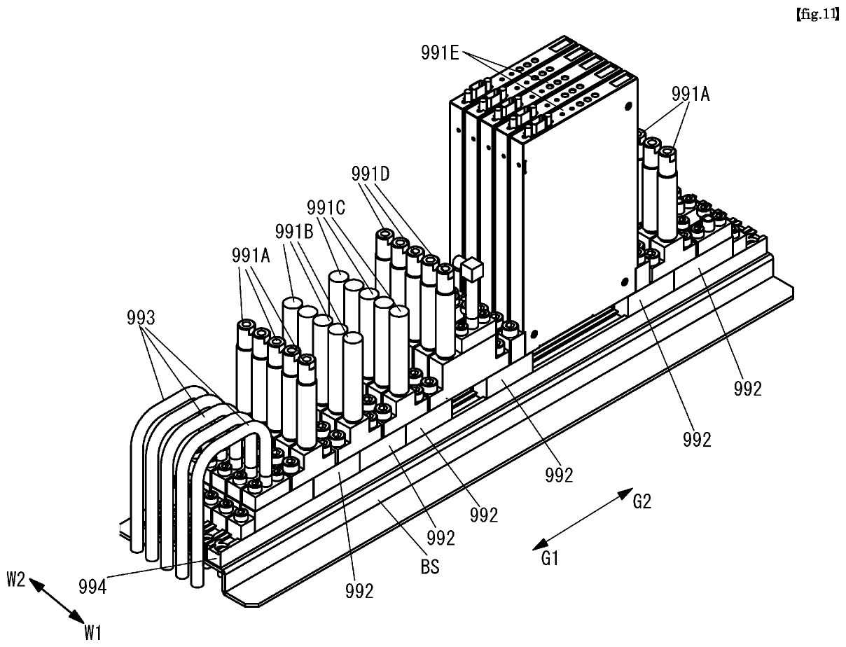

Next, referring to FIG. 10, an application of the above-described valve device 1 will be described.

Semiconductor manufacturing apparatus 980 shown in FIG. 10 is an apparatus for performing a semiconductor manufacturing process by the ALD method, where 981 is a process gas supply source, 982 is a gas box, 983 is a tank, 984 is a control unit, 985 is a processing chamber, and 986 is an exhaust pump.

In the semiconductor manufacturing process by the ALD method, it is necessary to precisely adjust the flow rate of the process gas, and along with the increase of the diameter of the substrate, it is also necessary to secure a certain amount of flow rate of the process gas.

Gas box 982 is an integrated gas system (fluid control device) housed in the box by integrating various fluid control devices such as open-close valves, regulators, mass flow controllers, etc. in order to supply accurately metered process gas to the processing chamber 985.

The tank 983 functions as a buffer for temporarily storing the process gas supplied from the gas box 982.

The control unit 984 executes the supply control of the drive fluid G to valve device 1 and, trough the adjusting actuator 100, the adjustment control of the opening amount when the valve is opened.

The processing chamber 985 provides a sealed processing space for forming a film on a substrate by the ALD method.

An exhaust pump 986 draws a vacuum within the processing chamber 985.

According to the system configuration as described above, by sending a command for adjusting the flow rate from the control unit 984 to valve device 1, it is possible to initially adjust the process gas. Further, even in the middle of executing the film forming process in the processing chamber 985, it is possible to adjust the flow rate of the process gas, and it is possible to optimize the process gas flow rate in real time. That is, according to the semiconductor manufacturing method using the semiconductor manufacturing apparatus 980 according to the present embodiment, in the process step by the process gas, it is possible to more easily adjust the opening amount of the valve when it is opened.

In the above application example, valve device 1 is used in a semiconductor manufacturing process by the ALD method, but the present invention is not limited to this, and the present invention can be applied to any object requiring precise flow rate control, such as an atomic layer etching (ALE) method.

In the above embodiment, a piston incorporated in a cylinder chamber operated by a gas pressure is used as the main actuator, but the present invention is not limited thereto, and various optimum actuators can be selected according to the controlled object.

Incidentally, if the open position of the operating member 40 is mechanically adjusted by the adjusting body 70 with high accuracy in advance, then, by using the adjusting actuator 100 for high-precision control of the position of the subsequent operating member 40, it is possible to reduce the maximum stroke of the adjusting actuator 100 as much as possible (together with miniaturization of the adjusting actuator), and to achieve high-precision fine adjustment of the position of the operating member 40 and high-precision position control.

In the above embodiment, a so-called normally closed type valve is exemplified, but the present invention is not limited to this, and is also applicable to a normally open type valve. In this case, for example, the opening degree of the valve body may be adjusted by the adjusting actuator.

In the above embodiment, the adjusting actuator 100 is configured to support (receive) the force acting on operating member 40, but the present invention is not limited thereto, and the configuration may be such that the positioning of the operating member 40 in the open position is performed mechanically, and only the potion of the operating member 40 in the open-close direction is adjusted by the adjusting actuator without supporting the force acting on the operating member 40.

In the above embodiment, a diaphragm is exemplified as a valve element, but the present invention is not limited thereto, and other types of valve elements may be employed.

In the above embodiment, valve device 1 is placed outside of the gas box 983 as a fluid control device, but it is also possible to include valve device 1 of the above embodiment in a fluid control device in which various fluid devices such as open-close valves, regulators and a mass flow controllers are integrated and housed in a box.

### REFERENCE SIGNS LIST

1 Valve device
10 Valve body
12 First flow path
13 Second flow path
15 Valve seat
20 Diaphragm
25 Presser adapter
30 Bonnet
38 Diaphragm presser
40 Operating member
45 Flange portion
50 Casing
60 Main actuator
61,62 Piston
63 Bulkhead
70,70A adjusting body
71 Adjusting body flow passage
80 Actuator presser
81 Actuator presser flow passage
90 Coil spring
100 Adjusting actuator
103 Base end portion
105 Wiring
150 Pipe joint
160 Pipe
981 Process gas supply source
982 Gas box
983 Tank
984 Control unit
985 Processing chamber
986 Exhaust pump
980 Semiconductor manufacturing apparatus
991A Open-close valve (2-way valve)
991B Regulator
991C Pressure gauge
991D Open-close valve (3-way valve)
991E Mass flow controller
992 Flow path block
993 Introduction pipe
994 Rail member
A1 Opening direction
A2 Closing direction
C1, C2 Cylinder chamber
Ch1,Ch2 First pneumatic flow path, Second pneumatic flow path
SP Space
OR O-ring
G Drive fluid
Lf Lift amount before adjustment
Lf+, Lf− Lift amount after adjustment

1. A valve device comprising:
a valve body having a first flow path and a second flow path formed therein;
a valve element for closing an opening of the first flow path to shut off a gateway between the first flow path and the second flow path, and for opening the opening of the first flow path to make the first flow path and the second flow path communicate with each other;
an operating member moving between a closed position for closing the opening of the valve body and an open position for opening the opening; and
an adjusting actuator for defming the open position of the operating member and having an electrically driven material made of a compound that deforms in response to a change in an electric field, the adjusting actuator configured to change the defined open position by deformation of the electrically driven material.

2. The valve device according to claim 1, wherein the adjusting actuator has a structure in which a plurality of elements including the electrically driven material are stacked in a moving direction of the operating member.

3. The valve device according to claim 1, wherein the electrically driven material is a piezoelectric material or an electrically driven polymeric material.

4. The valve device according to claim 3, wherein the electrically driven polymeric material is any of electrical EAP, nonionic EAP and ionic EAP.

5. The valve device according to claim 1, further comprising: an elastic member for urging the operating member to the closed position and a main actuator for urging the operating member to the open position against the elastic member.

6. The valve device according to claim 5, wherein the main actuator moves the operating member to the open position by a drive fluid supplied through a flow path a part of which is formed by a side of the adjusting actuator.

7. The valve device according to claim 1, further comprising an annular actuator presser for gripping the adjusting actuator and a wire connected to the adjusting actuator on the inside of actuator presser, wherein the actuator presser has an actuator presser flow passage for making the inside and the outside of actuator presser communicate with each other.

8. The valve device according to claim 7, further comprising an adjusting body attached to the casing of the main actuator and for connecting actuator presser, wherein the adjustment body has an adjustment body flow passage that opens to the inside of the actuator presser, supplies a drive fluid, and allows a wiring to pass therethrough.

9. A flow control method comprising using the valve device as claimed in claim 1, for regulating a flow rate of a fluid.

10. A fluid control device comprising a plurality of fluid devices, wherein the fluid devices include the valve device as claimed in claim 1.

11. (canceled)

12. (canceled)
